(19) United States
(12) Patent Application Publication
(10) Pub. No.: US 2012/0080321 A1
(43) Pub. Date: Apr. 5, 2012

(54) Display Device

(76) Inventors: David Stephen Thomas, Cambridgeshire (GB); Philip Gareth Bentley, Cambridgeshire (GB)

(21) Appl. No.: 13/376,822

(22) PCT Filed: Jun. 4, 2010
(86) PCT No.: PCT/GB10/50941

§ 371 Date: Dec. 7, 2011

(30) Foreign Application Priority Data
Jun. 8, 2009 (GB) 0909778.3

(51) Int. Cl. C25F 3/02; B44C 1/22; C25F 7/00

(52) U.S. Cl. 205/640; 204/242

(57) ABSTRACT

A display device comprises a first insulating substrate (10) carrying on one surface thereof a first electrically conductive material (12) constituting a first electrode; a second electrically conductive material (16) constituting a second electrode disposed in opposed relation to the first electrically conductive material and spaced therefrom; and an electrolyte providing a conductive pathway between the first and second electrically conductive materials. In use of the device, a potential difference is applied between the first and second electrically conductive materials, causing the first material to be fully removed from the first substrate selectively in one or more regions where the first and second materials are directly opposed, thus forming a detectable image. Because the first material has been fully removed from one or more regions of the first substrate, and because the first substrate is not electrically conductive, the process is not reversible and so results in a fixed display. This constitutes a permanent record that is not dependent on electrical power, unlike, say, an LCD. The display produced on the device of the invention is thus irreversible and permanent.

### FIELD OF THE INVENTION

This invention relates to display devices, and is particularly concerned with devices producing a fixed display, i.e. a display that is irreversible and permanent.

### BACKGROUND TO THE INVENTION

Numerous different types of display devices are known, with one commonly used device comprising a liquid crystal display (LCD). These devices are very versatile, but are reversible and also generally require power to maintain the display.

There are some circumstances where an irreversible, permanent display would be beneficial.

U.S. Pat. No. 6,641,691 discloses an irreversible thin film display in which a thin metal film is chemically removed by exposure to a chemical clearing agent such as an oxidant, acid, salt or alkali, to reveal permanently information initially obscured by the metal film. The device finds application, e.g. as game pieces, message cards, security devices or elapsed time indicators.

The present invention aims to provide an alternative irreversible display.

### SUMMARY OF THE INVENTION

In one aspect, the invention provides a display device comprising a first insulating substrate carrying on one surface thereof a first electrically conductive material constituting a first electrode; a second electrically conductive material constituting a second electrode disposed in opposed relation to the first electrically conductive material and spaced therefrom; and an electrolyte providing a conductive pathway between the first and second electrically conductive materials.

The above defines the device prior to use, i.e. in unused condition.

In use of the device, an electrical potential difference is applied between the first and second electrically conductive materials. The electrolyte completes the electrical circuit, causing the first material to be fully removed from the first substrate selectively in one or more regions where the first and second materials are directly opposed, thus forming a detectable image. Because the first material has been fully removed from one or more regions of the first substrate, and because the first substrate is not electrically conductive, the process is not reversible and so results in a fixed display. This constitutes a permanent record that is not dependent on electrical power, unlike, say, an LCD. The display produced on the device of the invention is thus irreversible and permanent.

The first substrate is translucent or transparent to provide an optically detectable image, with bare regions of the substrate typically being visually distinguishable from regions of the substrate carrying electrically conductive material.

The first insulating substrate may be rigid or flexible and conveniently comprises a layer, sheet or film of any suitable material including glass and plastics material (possibly coloured), e.g. polyethyleneterephthalate (PET) film. The first substrate and/or the first electrically conductive material do not consist of or include a transparent conducting oxide such as indium tin oxide (ITO), unlike known reversible displays e.g. as disclosed in EP 0901034.

The second electrically conductive material is preferably carried on one surface of a second substrate that constitutes a carrier. The second substrate is typically also of electrically insulating material or at least has an electrically insulating layer on which the conductive material is carried. The second substrate may be rigid or flexible, and conveniently comprises a layer of glass or plastics material. The second substrate may be transparent, translucent or opaque.

The first and second electrically conductive materials are each typically in the form of a layer deposited on or adhered to the associated substrate as a coating or in patternwise manner. Deposition techniques are well known to those skilled in the art, and include vacuum deposition, evaporation, including thermal evaporation, electron beam evaporation, vacuum evaporation, sputtering etc. Suitable metal patterning techniques include shadow mask evaporation, photolithographic etching, screen printing, semi-additive plating, and methods as disclosed in WO 2004/068389, WO 2005/045095 and WO 2005/056875, particularly inkjet printing of ink comprising an activator (e.g. catalyst or catalyst precursor), i.e. a catalytic ink, followed by electroless deposition to produce metal deposits. This technique is particularly beneficial for patternwise deposition, as the pattern can be readily varied without the need for retooling.

It is important that the first electrode is visible, i.e. not transparent, so it is possible to distinguish visually, e.g. with the naked eye, between the presence and absence of the first electrically conductive material on the first substrate. The first electrode is preferably opaque, i.e. such that the structure of the second electrode is not visually discernible through the first electrode on the first substrate. This is to be contrasted with reversible electrochromic display devices, e.g. as disclosed in WO 02/075441 and WO 98/14825, which have a transparent electrode, e.g. of indium tin oxide, to permit viewing of electrolyte colour changes.

The first electrically conductive material typically has a thickness of less than 1 micron, preferably in the range of a few tens of nm to about 1 micron, and is desirably reasonably thin, as thin layers are removed more rapidly in use. The first electrically conductive material preferably has a thickness of less than 500 nm, more preferably less than 300 nm. The material may have a thickness of less than 200 nm, e.g. about 150 nm, and possibly less than 100 nm, e.g. about 50 nm, although such very thin (50 nm) layers may tend to corrode with time reducing the lifetime of the device and so are desirably avoided. Good results have been obtained using layers with a thickness in the range 200 nm to 300 nm.

The second electrically conductive material typically has a thickness of up to about 50 micron, although usually this material will be thinner than this. The second electrically conductive material may be of similar thickness to (although possibly thicker than) the first electrically conductive material. Good results have been obtained with second electrically conductive materials having a thickness in the range 1 to 2 micron.

The electrically conductive materials are typically metals. The first and second electrically conductive materials may be the same or different, but are preferably the same, with suitable metals including copper, aluminium, gold, silver, nickel etc. Non-metallic conductive materials include materials such as carbon, silver ink, semiconductor materials etc., and these find particular application as the second electrically conductive material.

It is preferred that the first and second electrodes are of materials having the same or similar electrode potential, as otherwise an electrolytic cell can be produced which will cause the deplating reaction to occur spontaneously. This produces corrosion, reducing the lifetime of the display. It is thus preferred that the first and second electrodes are of the same metal (the best practical way of having materials of the same electrode potential) to prevent such spontaneous reaction and so increase the lifetime of the device.

The electrolyte is preferably not in solid form and is desirably in liquid or gel form. The electrolyte may be in the form of an aqueous solution or an organic solution, and is preferably a solution in a non-volatile organic solvent such as ethylene glycol or similar high boiling point organic material (having a boiling point greater than 150° C.), as such materials are less likely to evaporate from the device over time.

The electrolyte preferably comprises a salt, preferably of a Group I or Group II metal, preferably Group I, e.g. a lithium or sodium salt, as these are smaller, more mobile and more soluble. The salt is preferably a halide or a nitrate, preferably of a Group I or Group II metal, and good results have been obtained with chlorides and nitrates such as sodium chloride and lithium nitrate. Other electrolytes have also been used successfully, including copper (II) tetrafluoroborate, e.g. in solution in ethylene glycol. Salt concentration is not thought to be critical, and good results have been obtained with concentrations of about 5% by weight.

The first and second electrically conductive materials must be spaced apart for the device to function. The spacing affects the sharpness of the resulting image and also the current flow, and hence the speed of removal of the first material, with the two materials preferably being as closely spaced as possible for sharp, rapid results. The spacing may be in the range 100 nm to 1 mm, and is typically in the range 1 micron to 100 micron.

The device is constructed to keep the first and second electrically conductive materials spaced apart and to avoid contact. This is conveniently effected using techniques known in the construction of LCD displays, including use of gasket materials as spacers, printed spacer materials, and inclusion of small glass or plastic beads in the electrolyte liquid.

The device is preferably constructed to seal the electrolyte between the first and second electrically conductive materials, and this is conveniently effected using methods known in the construction of LCD displays, including the use of sealants, epoxy materials, silicones, pressure-sensitive tapes, adhesives etc.

Suitable construction techniques for the device will be readily apparent to those skilled in the art.

The device conveniently includes electrical contacts for connecting to means for applying a potential difference therebetween.

The device may include, or be used with, associated control electronics such as a microprocessor control.

The device may include, or be used with, an appropriate “writer” device for activating the device and applying a potential difference between the first and second electrically conductive materials in response to appropriate conditions or stimulus. The device, in use, may be activated in stages, causing progressive or selective removal of different regions of first electrically conductive material from the first substrate.

In use of the device, the first electrically conductive electrode is preferably maintained at a higher, more positive potential relative to the second electrically conductive electrode, to cause the desired material removal.

Appropriate voltages and timings for material removal depend on the materials and thickness used, but for devices as envisaged as discussed above a potential difference of up to about 5V is suitable, e.g. about 3V, and material is found to be fully removed after a time of, e.g., about 0.5 to 10 seconds.

As noted above, each of the first and second electrically conductive materials may be in the form of a continuous coating or a pattern, and many possibilities are envisaged.

In a very simple embodiment, both the first and second materials are in the form of a continuous coating in opposed relation, and on application of an appropriate potential difference for a suitable time, all of the first material is removed. This results in a simple yes/no type display.

As a further possibility, the first material may be in the form of a continuous coating, with the second material being patterned, which will cause material to be removed from the first electrode in a pattern corresponding to that of the second material. Any desired pattern may be used, simple or complex, consisting of one or more discrete, separate regions as required. In the case of discrete regions, these may have independent electrical contacts for individual and selective activation, typically at different times or under different conditions, or a common contact for simultaneous activation. Portions of a pattern leading to an electrical contact may optionally be masked with insulating material if required, to prevent those portions from being included in the resulting image of the display. Alternatively, the second material may be in the form of a continuous coating, with the first material present in a pattern.

By patterning the first and second materials as a series of inclined, e.g. orthogonal stripes, e.g. with the first material as a series of vertical stripes and the second material as a series of horizontal stripes, a matrix of addressable pixel elements can be produced so that more complex images can be defined from the row and column matrix pattern.

In this case, narrow strips of insulating material are desirably selectively located over parts of the strips of the second conductive material to prevent electrical isolation of pixel elements downstream of a removed element.

More complex patterns, such as the standard seven segment digit display pattern, can also be employed.

The display device of the present invention finds application in a variety of areas, including as displays for use with medical diagnostic devices such as lateral flow devices, e.g. pregnancy test sticks, in place of a LCD device, to provide a permanent record of the result not dependent on a power source; as a tamper-evident display; as a marker on perishable goods, e.g. high value goods such as vaccines, activated in response to specified time and/or temperature conditions; on a multi-use token or card e.g. for public transport, activated by insertion into an appropriate “writer” device etc. Other uses will be apparent to those skilled in the art.

The device may have any desired size and shape depending on the intended use and size of display required, and typically may be, e.g. credit card size or smaller, e.g. 300 mm by 100 mm.

The invention also includes within its scope a device in accordance with the invention after use (partial or complete) wherein some or all of the first electrically conductive material has been fully removed from the first substrate by application of a potential difference between the first and second layers to produce a detectable image.

If the use is partial, the device may be subjected to one or more further uses.

The invention also provides a method of producing a non-reversible image on a display device in accordance with the invention, comprising applying a potential difference between the first and second electrically conductive materials so that the first material is fully removed from the first substrate selectively in one or more regions where the first and second materials are directly opposed to produce a detectable non-reversible image on the display. The method may be repeated. The method may be controlled by control electronics such as a microprocessor control associated with the device or in a separate “writer” device.

The invention will be further described, by way of illustration, with reference to the accompanying figures, in which:

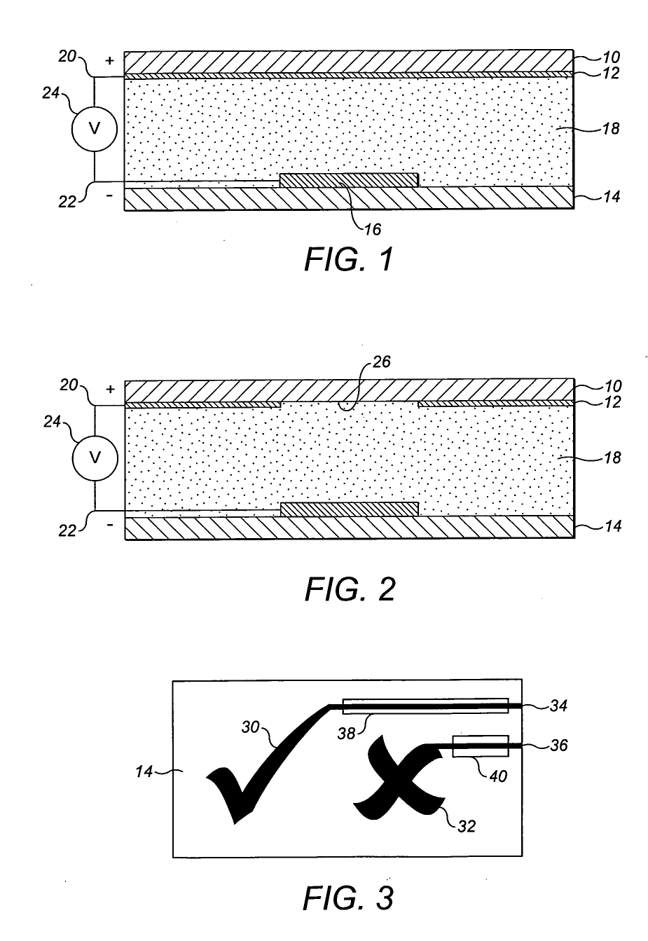

FIG. 1 is a schematic sectional view of a display device in accordance with the invention;

FIG. 2 is a view similar to FIG. 1, showing the device of FIG. 1 after use to produce an image;

FIG. 3 is a plan view of an example of a second substrate of the device of FIGS. 1 and 2, showing a pattern of metal second electrode;

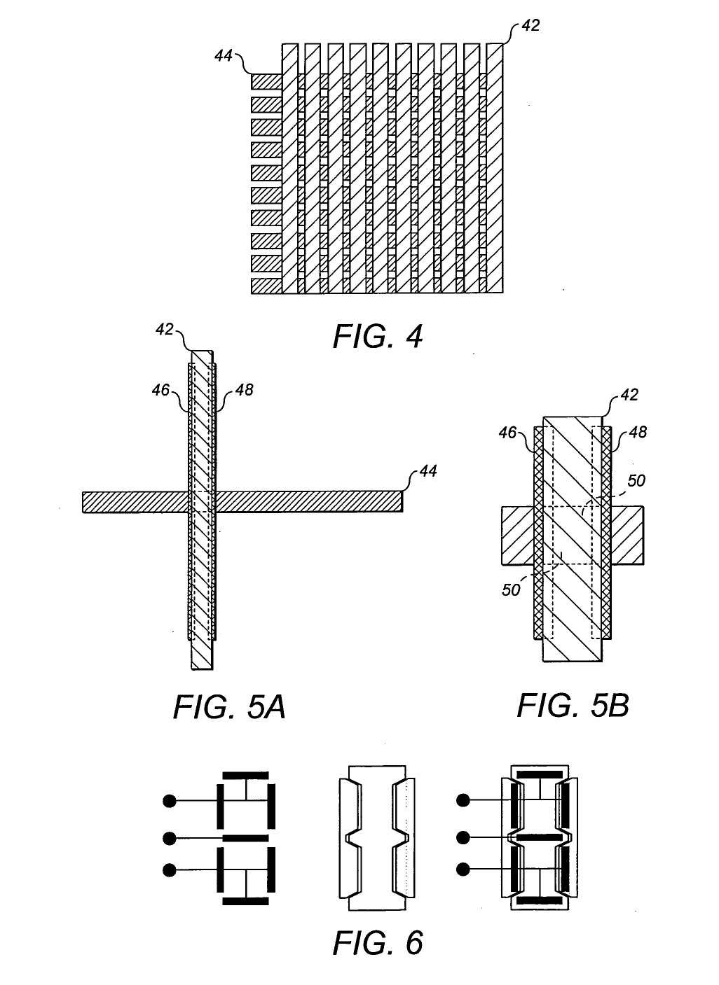

FIG. 4 is a schematic plan view of a first electrode in the form of an array of vertical stripes and a second electrode in the form of an array of horizontal stripes forming part of a display device embodying the present invention;

FIG. 5A shows to an enlarged scale part of the arrays of FIG. 4;

FIG. 5B shows to a further enlarged scale part of FIG. 5B after image formation; and

FIG. 6 illustrates electrode patterns for producing a seven segment digit display in a display device in accordance with the invention.

### DETAILED DESCRIPTION OF THE DRAWINGS

The display device shown schematically in FIG. 1 (not to scale) comprises a rectangular sheet 10 or film of transparent plastics material, e.g. of PET, constituting the first substrate. The lower face of the sheet 10 carries a continuous coating of a thin layer of a conductive metal 12, e.g. copper constituting a first electrode. A second rectangular sheet or film of plastics material 14 of similar size and shape to sheet 10 constitutes a second substrate. The upper face of sheet 14 carries a partial coating of a conductive metal 16 e.g. copper, constituting a second electrode, the second electrode being thicker than the first electrode. The substrates are in parallel, spaced apart relationship, defining a cavity 18 therebetween that is filled with an electrolyte, e.g. 5% aqueous solution of sodium chloride. The sides of the cavity are sealed. Electrical connections 20, 22 lead from the first and second electrodes, respectively, to a device 24 for applying a potential difference to the electrodes.

In use, a potential difference is applied to the electrodes, e.g. 3V for up to 10 seconds, with the first electrode being maintained at a positive potential relative to the second electrode. This results in metal from the first electrode 12 which is directly opposed to the pattern of the second electrode 16 being fully removed from the first substrate 10 in a stripping or de-plating step (based on the technique of electroplating), leaving an uncoated region 26 of the first substrate corresponding to the second electrode, as shown in FIG. 2. This provides a contrast in the first electrode, constituting an image that is visually detectable. Once the pattern has been formed on or “burned” into the first electrode, the material above the second electrode is insulating so it is not possible for metal to be redeposited, even when the voltage is removed or reversed, so the image on the display is irreversibly, constituting a fixed, permanent display.

The device may have any desired size and shape depending on the intended use and size of display required, and typically may be, e.g. credit card size or smaller, e.g. 300 mm by 100 mm.

The first electrode typically has a thickness of up to 1 micron, and is generally less than 500 nm, preferably in the range 200 nm to 300 nm. The second electrode is typically thicker than the first electrode, e.g. up to about 50 micron, generally being in the range 1 to 2 micron.

The spacing between the first and second electrodes is typically in the range 100 nm to 1 mm and is ideally as small as possible.

FIG. 3 shows an example of a second substrate 14 of the device of FIGS. 1 and 2, where the second electrode 16 is in the form of a pattern of metal, in this case a tick symbol 30 and a cross symbol 32, each with an associated conductive track 34, 36 leading to the edge of the substrate 14 for connection to device 24. Strips of insulating material 38, 40 are optionally provided over the tracks 34, 36 to prevent burning an image of the tracks. In use of the device, by application of a potential difference to track 34, or track 36, the associated symbol is “burnt” into the display. In this case, it will typically be desired to display only one of these images, e.g. to indicate a pass/fail, yes/no result, but with other patterns, possibly having more elements, it may be desired to burn several different images, simultaneously or sequentially, and this can be readily achieved by connecting the appropriate track to the device 24, typically under the control of a microprocessor (not shown).

By patterning the first electrode as an array of vertical stripes 42 and the second electrode as an array of horizontal stripes 44, as shown in FIG. 4, a matrix of addressable pixels can be produced, so that more complex images can be defined.

The simple geometry of FIG. 4 would mean that once a pixel had been burned it would break the conductive track on the first electrode thus preventing writing of further pixels downstream. This could be remedied by two methods:

1. By building up the burnt image pattern from the bottom row to the top row so no pixels that are to be burnt are isolated.
2. By providing, e.g. printing, insulating material over regions of the stripes 44 of the second electrode, e.g. in the form of vertical stripes, so that the pixels that are burned are narrower than the first electrode stripes 42. This is illustrated in FIGS. 5A and 5B, where FIG. 5A shows narrow vertical strips of insulating material 46, 48 printed on the second substrate, over the horizontal second electrodes 44, with FIG. 5B showing the region 50 of the first electrode 42 that will be burnt, illustrating that the vertical first electrode track 42 is not completely broken so downstream pixels can be subsequently burnt.

In a complex image formed from an array as shown in FIG. 4, individual pixels may be burnt sequentially or simultaneously, but typically will be developed sequentially row by row or column by column.

FIG. 6 illustrates an electrode pattern for producing a seven segment digital display in a device embodying the invention.

### EXAMPLES

### Example 1

A simple prototype display device having the general construction shown in FIG. 1 was produced, using a thin film of transparent PET as the first substrate, having a size of about 500 mm by 200 mm, carrying a 50 nm thick coating of sputtered aluminium forming a continuous coating and constituting the first electrode. A similar film of PET was used as the second substrate, bearing a pattern of copper as the second electrode. The copper was produced by inkjet printing a catalytic ink in the desired pattern, followed by electroless deposition of copper plated to produce material having a sheet resistance of about 30 mΩ□. In particular, a palladium acetate activator solution was applied by inkjet printing, generally as described in WO 2004/068389. The deposited material was UV cured, resulting in formation of an activator layer on the substrate. The printed substrate was immersed in a bath containing an aqueous solution of dimethylamine borane (DMAB) to reduce the palladium acetate to palladium. After washing in water, the substrate was subjected to an electroless deposition process for deposition of copper metal on the palladium.

A 5% by weight aqueous sodium chloride solution was used as the electrolyte. A potential difference of 4V was applied across the electrodes, with the aluminium first electrode held at +4V, and this resulted in aluminium being fully deplated from the first substrate in a pattern corresponding to that of the second electrode within 10 seconds, leaving an area on the first substrate that looked darker due to the reduced reflection, thus constituting an image that is readily discernible visually. The image remained after removal of the potential difference, and constitutes a fixed, irreversible, permanent record on the display device. Because two dissimilar metals (aluminium and copper) were used as the electrodes, this resulted in the device constituting an electrochemical cell which caused the image to degrade slowly over time. The first substrate bearing the image may be removed from the remainder of the device for storage, obviating this problem.

### Example 2

A further simple prototype was constructed as described in Example 1, using two copper electrodes, each with a thickness in the range 200 to 300 nm. Using the same electrode materials prevented the electrode degradation with time noted in Example 1. In this case a potential difference of 2.4V was used and produced full deplating of the first electrode in a pattern corresponding to that of the second electrode in less than 10 seconds.

### Example 3

A further simple prototype was constructed as described in Example 2, using a 5% by weight solution of lithium nitrate in ethylene glycol as the electrolyte. This functioned well and reduced any likelihood of electrolyte drying out over time as may occur with aqueous electrolytes if the device is not fully sealed. The devices of Example 3 have survived several months at 45° C. without electrolyte drying.

### Example 4

A further simple prototype was constructed as described in Example 2, using a 5% by weight solution of copper (II) tetrafluoroborate in ethylene glycol as the electrolyte. This functioned well, giving full depletion of the first electrode in the pattern corresponding to the second electrode within 5 seconds on application of a potential difference of 2.4V.

1. A display device comprising a first electrically insulating substrate carrying on one surface thereof
a first electrically conductive material constituting a visible first electrode;
a second electrically conductive material, constituting a second electrode disposed in opposed relation to the first electrically conductive material, spaced and electrically isolated from the first electrode; and
an electrolyte providing a conductive pathway between the first and second electrically conductive materials.

2. A device according to claim 1, wherein the second electrically conductive material is carried on one surface of a second electrically insulating substrate.

3. A device according to claim 1, wherein the first electrically conductive material has a thickness of less than about 500 nm.

4. A device according to claim 1, wherein the first substrate and/or the first electrically conductive material do not consist of or include a transparent conducting oxide.

5. A device according to claim 1, wherein the first and second electrically conductive materials have the same or similar electrode potential.

6. A device according to claim 1, wherein the first electrically conductive material is a metal.

7. A device according to claim 6, wherein the first and second electrically conductive materials are the same metal.

8. A device according to claim 1, wherein the electrolyte is in liquid or gel form.

9. A device according to claim 1, wherein the electrolyte comprises a salt of a Group I or Group 11 metal.

10. A device according to claim 1, wherein the electrolyte comprises a halide or nitrate.

11. A device according to claim 1, wherein the first and second electrically conductive materials are spaced apart by a distance in the range 100 nm to 1 mm, preferably 1 micron to 100 micron.

12. A device according to claim 1, wherein the first electrically conductive material is in the form of a continuous coating, and the second electrically conductive material is patterned.

13. A device according to claim 1, wherein the first and second electrically conductive materials are each in the form of an array of strips, with the arrays inclined with respect to each other.

14. A device according to claim 1, wherein insulating material is selectively located over parts of the strips of the second conductive material.

15. A device according to claim 1, wherein the first and/or second conductive materials are deposited by inkjet printing of a catalytic ink, followed by electro less deposition of metal.

16. A device according to claim 1 after use, wherein the first electrically conductive material has been fully removed from the first substrate in one or more regions by application of a potential difference between the first and second electrodes to produce a detectable image.

17. A method of producing a non-reversible image on a display device according to claim 1, comprising applying a potential difference between the first and second electrically conductive materials so that the first material is fully removed from the first substrate selectively in one or more regions where the first and second materials are directly opposed to produce a visually detectable non-reversible image on the display.

18. A device according to claim 1, wherein the first electrically conductive material has a thickness of less than about 300 nm or less than about 200 nm.
